(19) United States
(12) Patent Application Publication
(10) Pub. No.: US 2021/0379830 A1
(43) Pub. Date: Dec. 9, 2021

(54) DETERMINING FUSING ENERGY PROFILES IN 3D PRINTING

(71) Applicant: Hewlett-Packard Development Company, L.P., Spring, TX (US)

(72) Inventors: David Champion, Corvallis, OR (US); Anthony Holden, Corvallis, OR (US); Andrew L. Van Brocklin, Corvallis, OR (US); Daniel Fradl, Corvallis, OR (US)

(73) Assignee: Hewlett-Packard Development Company, L.P., Spring, TX (US)

(21) Appl. No.: 17/255,149

(22) PCT Filed: Feb. 26, 2019
(86) PCT No.: PCT/US2019/019623

§ 371 Date: Dec. 22, 2020

(51) Int. Cl. B29C 64/291; B29C 64/393; B29C 64/277; B29C 64/165; B29C 64/295

(52) U.S. Cl. CPC B29C 64/291; B29C 64/393; B33Y 10/00; B29C 64/165; B29C 64/295; B29C 64/277

(57) ABSTRACT

In an example implementation, a method of 3D printing includes receiving a 3D object model that defines the shape of an object to be printed in a layer-by-layer build process, and determining a desired thermal profile based on the shape of the object. For each object layer, a fusing energy radiation pattern is determined based on the desired thermal profile, and an electromagnetic energy emitter array is controlled to deliver fusing energy to the object layer according to the energy radiation pattern.

### BACKGROUND

Additive manufacturing machines can produce three-dimensional (3D) objects by layering and solidifying build material in the shape of the objects. 3D printers and other additive manufacturing machines can convert digital 3D object models, such as CAD (computer aided design) models, into physical objects. Data defining a 3D object model can be processed into 2D data slices that each define a portion or portions of a layer of build material to be formed into a physical object. In some examples, inkjet printheads can selectively print (i.e., deposit) liquid functional agents, such as fusing agents or binder liquids, onto portions of each layer of build material that are to become part of the object. The liquid agents can facilitate the solidification of the build material within the printed areas. For example, fusing energy can be applied to a build material layer to thermally fuse build material in areas where a liquid fusing agent has been printed. The fusing and solidification of printed areas from numerous layers forms the object into the shape of the 3D object model.

### BRIEF DESCRIPTION OF THE DRAWINGS

Examples will now be described with reference to the accompanying drawings, in which:

FIG. 1A is a plan view that shows a block diagram of an example 3D printing system suitable for determining a fusing energy delivery profile based on the shape of a 3D object to be printed;

FIG. 1B is a sectional elevation viewed along both lines A and lines B of the example 3D printing system shown in FIG. 1A;

FIG. 2 shows a graph of an example fusing energy delivery profile that can be determined based on the shape of an object;

FIG. 3 shows an example of a rectangular shaped object near the end of a build process in which fusing energy is being applied by a microwave emitter array to the final layer;

FIG. 4 shows a block diagram of an example controller; and,

FIGS. 5, 6, and 7, are flow diagrams showing example methods of 3D printing.

Throughout the drawings, identical reference numbers designate similar, but not necessarily identical, elements.

### DETAILED DESCRIPTION

In some additive manufacturing processes, such as some 3D printing processes, for example, 3D objects or parts can be formed on a layer-by-layer basis where each layer is processed and portions thereof are combined with subsequent layers until the 3D object is fully formed. The build material used for producing 3D objects is generally referred to herein as being powdered build material, such as powdered nylon. However, there is no intent to limit the form or type of build material that may be used when producing a 3D object from a 3D digital object model. Various forms and types of build materials may be appropriate and are contemplated herein. Examples of different forms and types of build materials can include, but are not limited to, short fibers that have been cut into short lengths or otherwise formed from long strands or threads of material, various powder and powder-like materials including plastics, ceramics, metals, and the like. In some examples, a suitable build material can include PA12 build material commercially known as V1R10A “HP PA12” available from HP Inc.

In some 3D printing processes, layers of a 3D object being produced can be patterned from 2D slices of a digital 3D object model, where each 2D slice defines a portion or portions of a powder layer that are to form a layer of the 3D object. Information in a 3D object model, such as geometric information that describes the shape of the 3D model, can be stored as plain text or binary data in various 3D file formats, such as STL, VRML, OBJ, FBX, COLLADA, 3MF, and so on. Some 3D file formats can store additional information about 3D object models, such as information indicating colors, textures and/or surface finishes, material types, and mechanical properties and tolerances.

The information in a 3D object model can define solid portions of a 3D object to be printed or produced. To produce a 3D object from a 3D object model, the 3D model information can be processed to provide 2D planes or slices of the 3D model. In some examples, 3D printers can receive and process 3D object models into 2D slices. In some examples, 3D printers can receive 2D slices that have already been processed from 3D object models. Each 2D slice generally comprises an image and/or data that can define an area or areas of a build material layer (e.g., powder) to be solidified during a 3D printing process. Thus, a 2D slice of a 3D object model can define areas within a powder layer as portions of an object layer that are to be printed with a liquid functional agent (e.g., a fusing agent) and subsequently solidified. Conversely, areas within a powder layer not defined as portions of an object layer, comprise non-object areas where the powder is not to be solidified. Non-object areas are often not printed with a liquid functional agent, but in some cases they may be printed with a detailing agent that can be selectively applied around object contours, for example, to cool the surrounding build material and keep it from fusing.

In some examples of powder-based, fusing agent 3D printing systems, powdered build material layers can be spread over a platform or print bed within a build area. As noted above, a liquid functional agent (i.e., a fusing agent) can be printed onto each build material layer in areas where the particles of powdered material are to be fused together or solidified to form an object layer as defined by a corresponding 2D slice of a 3D object model. Each build material layer can be exposed to a fusing energy to thermally fuse together and solidify particles of powdered material in the object layer areas that have been printed with the fusing agent. This process can be repeated, one build material layer at a time, until a 3D object has been formed from fused object layers within a build volume of the build area.

In some examples of such powder-based, fusing agent 3D printing systems, exposing the powdered build material to fusing energy includes irradiating the entire print bed uniformly, for example, with a bed-wide heating lamp. A heating lamp can include, for example, an infrared halogen lamp. In some examples, a fusing system can comprise a fusing module that includes a number of bed-wide heating lamps having different infrared ranges intended to heat the build material in different ways. For example, a fusing module can include a warming halogen lamp operable in the mid-IR (infrared) range (1.5-4.0 micron wavelength), and a fusing halogen lamp operable in the near-IR range (0.76-1.5 micron wavelength). Thus, a warming lamp can have a wavelength targeted to warm some or all material in a build material layer, while a fusing lamp can have a wavelength targeted for greater absorption by those areas of build material that have been printed with fusing agent.

Therefore, one way of providing some variability in the amount of fusing energy being applied to layers of powdered build material is to use different types of heating lamps with such fusing systems. Another way such fusing systems can provide variability in the amount of fusing energy being applied, is by adjusting the power level of the heating lamp between different material layers and/or across individual material layers. In either case, however, as a bed-wide heating lamp travels over the powder bed from one side to another, it emits heating energy indiscriminately such that the powder areas being traversed are flooded with heating energy. There is no particular pattern to the energy radiating from the bed-wide heating lamp. The energy emitted from the bed-wide lamp is uniform and is not adjustable to fit a specific pattern. As a result, such fusing systems can have problems with over fusing or under fusing when certain object shapes are being produced.

In general, therefore, fusing anomalies such as over fusing can occur when energy is applied in a constant manner with energy radiating indiscriminately from a heating energy source such as a bed-wide heating lamp. As layers of an object are printed and irradiated in this manner, the thermal profile that develops in the object can lead to excessive thermal diffusion between layers and/or the bleeding of heat into surrounding build material. The impact may be magnified for objects whose shapes include large segments of material to be fused, such as thick cubes. For example, when energy from a bed-wide heating lamp is repeatedly applied to all the layers of such a thick object, heat from the irradiated layers can seep or diffuse out of the object's core and move into previously and subsequently irradiated layers and into surrounding areas of powder layers that are not intended to be heated. The resultant thermal profile within the object can cause unintended fusing in some powder areas, as well as a significant variation in the amount of time it takes for different parts of the object to cool and solidify. In a thick object, the interior or core portion of the object can retain heat longer than outer portions that are near the edges of the object. Material in the outer portions of the object cools faster and solidifies sooner than the rest of the object, which can cause warping of the object from internal stress and differential densification of the material. The resulting object can have geometric and dimensional inaccuracies that adversely impact its appearance, strength, and other mechanical characteristics.

Accordingly, example methods and systems described herein enable the delivery of controlled energy radiation patterns across build material layers of an object. A different energy radiation pattern can be delivered to each build material layer by an electromagnetic energy emitter array (e.g., a microwave emitter array) controlled by a predetermined fusing energy delivery profile. The fusing energy delivery profile can be determined based on the shape of the object being produced as well as thermal and other characteristics of the powder material. The controlled energy radiation patterns can create a desired thermal profile during the object's build process that compensates for expected thermal diffusion between object layers and expected thermal seepage into areas of powder surrounding the object.

An energy delivery profile for a particular object can include fusing energy data determined in accordance with data that has been predetermined from prior empirical analysis of objects having similar shapes and build materials. For example, based on the shape of an object and the thermal characteristics of the material to be used to build the object, a look-up-table containing empirical data can be used to develop a fusing energy profile that can provide a distinct energy radiation pattern to be applied to each layer of the object during the build process (i.e., the 3D printing process). Data in an energy delivery profile can include, for each object layer, a set of electromagnetic (EM) energy emitter data, such as microwave emitter data, to control the energy output of each individual microwave emitter in a microwave emitter array as the array passes over each layer of build material. Each microwave emitter in an array generally comprises an antenna that can radiate a focused electromagnetic field in a near-field region of the antenna to deliver energy to a region of powder close to the antenna aperture. While the EM emitter array discussed herein and illustrated in the accompanying FIGs. generally comprises a microwave emitter array, there is no intention to limit the type of EM emitter array that may be applicable for use in the example methods and systems described herein. Various EM emitter arrays having individually controllable energy emitters may be suitable, such as a laser diode array with individually controllable laser diodes, a microwave emitter array with individually controllable microwave emitter tips/antennae, and so on.

In a particular example, a method of 3D printing includes receiving a 3D object model that defines the shape of an object to be printed in a layer-by-layer build process, and determining a desired thermal profile based on the shape of the object. For each object layer, a fusing energy radiation pattern is determined based on the desired thermal profile, and an electromagnetic (EM) energy emitter array is controlled to deliver fusing energy to the object layer according to the energy radiation pattern.

In another example, a 3D printing system includes a controller to receive a 3D object model that defines the shape of an object to be printed. The controller is to determine a fusing energy delivery profile based on the shape of the 3D object. The system includes a build surface to receive a layer of build material for the object, and a printing bar to dispense a liquid fusing agent onto a portion of the build material. The system also includes a microwave emitter array to deliver fusing energy to the portion of the build material in a particular radiation pattern according to the fusing energy delivery profile.

In another example, a method of 3D printing includes receiving a 3D object model of an object to be printed in a layer-by-layer print process. Based on the object's shape, an expected thermal profile and a desired thermal profile are determined. A fusing energy delivery profile is then determined to compensate for thermal diffusion between layers of the object from the expected thermal profile. For each object layer printed during the print process, a microwave emitter array is controlled to apply energy to the object layer according to the fusing energy delivery profile.

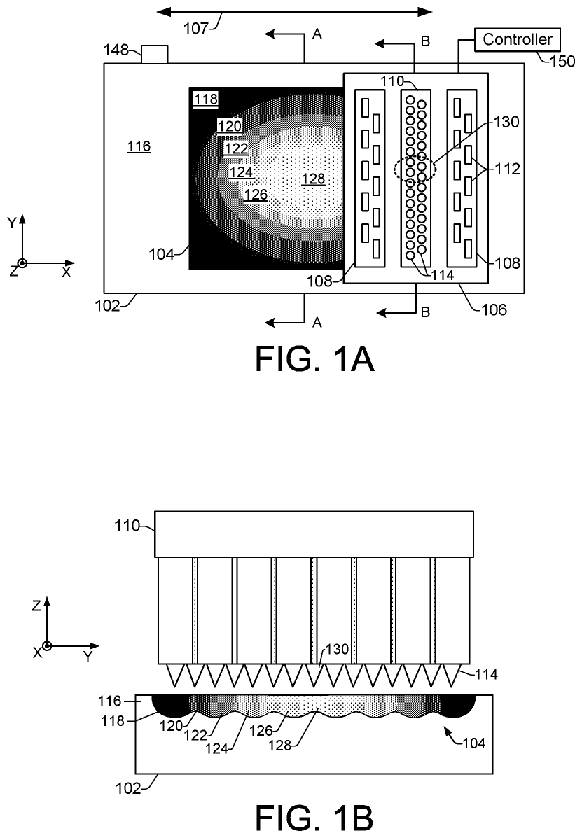

FIG. 1A is a plan view that shows a block diagram of an example 3D printing system 100 suitable for determining a fusing energy delivery profile based on the shape of a 3D object to be printed, and for applying fusing energy to each layer of the object according to the energy delivery profile. FIG. 1B is a sectional elevation viewed along both lines A and lines B of the example 3D printing system 100 shown in FIG. 1A. The 3D printing system 100 is shown by way of example, and the illustration of system 100 in FIGS. 1A and 1B is not intended to represent a complete 3D printing system. Thus, it is to be understood that an example system 100 may comprise additional components and may perform additional functions not specifically illustrated or discussed herein.

An example 3D printing system 100 includes a moveable print bed 102, or build platform 102 to serve as the floor to a work space or build area 170 (see FIG. 3) in which 3D objects can be generated. In some examples, the print bed 102 can move in a vertical direction (i.e., up and down) in the z-axis direction. A build area 170 of a 3D printing system 100 generally refers to a volumetric work space that develops above the moveable print bed 102 as the print bed moves vertically downward during the layer-by-layer 3D printing and solidification process. During this process, build material layers such as build material layer 104, can be successively spread over the bed 102 by a material dispenser (not shown) and processed to form a 3D object 172 (FIG. 3). A material dispenser can include, for example, a supply of build material (e.g. powder) and a build material spreader to dispense and spread layers of build material onto the build platform 102.

An example 3D printing system 100 also includes a fusing assembly 106 that can travel over the print bed 102 on a carriage (not shown), for example, bi-directionally in the X-axis, as indicated by the direction arrow 107 shown in FIG. 1A. An example fusing assembly 106 can include a printbar 108 and an electromagnetic (EM) energy emitter array/bar 110. An EM energy emitter array 110 can include, for example, a microwave emitter array 110, a laser diode array 110, or another EM energy emitter array 110 that comprises an array of individually controllable energy emitters, such as individually controllable microwave emitter tips, individually controllable laser diodes, and so on. In some examples, a fusing assembly 106 can include multiple printbars 108 such as the two printbars 108 shown in FIG. 1A, wherein one printbar 108 is located on either side of the microwave emitter array 110. This arrangement enables the fusing assembly 106 to function bi-directionally in the X-axis. That is, as the fusing assembly 106 traverses the print bed 102 in either direction, a leading printbar 108 can print liquid functional agent onto a build material layer 104, followed closely thereafter by the application of fusing energy from a microwave emitter array 110, which trails behind the leading printbar 108. A liquid functional agent can include any agent that facilitates the absorption of electromagnetic energy (e.g., microwave energy) by powdered build material that has been printed with the agent. Such liquid agents can include, for example, agents comprising polar molecules. In some examples, a liquid functional agent can include an ink-type formulation comprising carbon black, such as the fusing agent formulation commercially known as V1Q60A “HP fusing agent” available from HP Inc.

A printbar 108 can include multiple printheads 112 positioned lengthwise along the length of the printbar 108 in a manner such that liquid ejection nozzles (not shown) on the printheads 112 can provide full, or substantially full, print coverage across the width of a build material layer 104 (i.e., in the Y-axis) as the printbar 108 travels back and forth over the length of the print bed 102 in the X-axis. Thus, during a printing operation the fusing assembly 106 can travel over the print bed 102 in either X-axis direction to deposit liquid fusing agent onto a portion or portions of each new layer of build material. Printheads 112 can be implemented, for example, as thermal inkjet or piezoelectric inkjet printheads.

An example microwave emitter array 110 includes an array of microwave emitter tips 114, each comprising an antenna that can emit and focus electromagnetic energy in the near-field region of the antenna. In general, microwave emitters can transmit electromagnetic radiation at different frequencies and wavelengths that fall within the electromagnetic spectrum between radio waves and infrared light waves. Microwaves can include frequencies in a range between 1 and 100 GHz with wavelengths between 0.3 m and 3 mm. In some examples, microwaves can include a broader frequency range between 300 MHz and 300 GHz, with wavelengths between 1 m and 1 mm.

Focusing the microwave energy in the near-field region of a microwave antenna (i.e., a microwave emitter tip 114) helps direct the heating energy of the microwave emitter tip 114 to a limited area of the build material layer 104 in close proximity to the antenna aperture. The microwave emitter tips 114 can be arranged along the array 110 such that microwave heating energy can be directed at the entire area of a build material layer 104 as the array 110 passes over the print bed 102. For example, the microwave emitter tips 114 can be arranged in a line along the length of the array 110, or in multiple lines along the length of the array 110 as shown in FIG. 1B.

As the array 110 passes over a build material layer 104, each microwave emitter tip 114 can be controlled to emit varying levels of microwave energy. For each layer of build material, data from an energy delivery profile can control each microwave emitter tip 114 individually to emit varying or constant levels of microwave energy. For each layer of build material, therefore, data from the energy delivery profile indicates a fusing energy radiation pattern, and this data controls the individual microwave emitter tips 114 to radiate the pattern over the layer.

As shown in FIGS. 1A and 1B, a fusing energy radiation pattern is applied to a single build material layer 104 as the microwave emitter array 110 passes from left to right over the print bed 102 in the X-axis. The single build material layer 104 can be, for example, the first layer of an object shaped as a rectangular block such as the rectangular block object 172 shown in FIG. 3. As shown in FIG. 1A, the non-printed white area 116 comprises portions of powder build material in layer 104 that have not been printed with a fusing agent and that will not become part of the object. By contrast, other areas or portions of layer 104 shown as darkened areas 118, 120, 122, 124, 126, and 128, have been printed with fusing agent and will become part of the object. The darkened areas 118, 120, 122, 124, 126, and 128, provide an example of a fusing energy radiation pattern that is being applied to the single build material layer 104. For example, the darkest areas 118 can represent areas where microwave emitter tips 114 have delivered a high level of microwave energy, while the lightest area 128 can represent an area where microwave emitter tips 114 have delivered a low level of microwave energy.

It should be apparent that the level of microwave energy emitted by any one microwave emitter tip 114 can be varied as the microwave emitter array 110 traverses over the build material layer 104. For example, referring to FIG. 1A, as the array 110 moves from left to right over the print bed 102, emitter tips 130 begin at the left side of the layer 104 and can be controlled to emit a high level of microwave energy, as indicated by darkened area 118. As the array 110 continues moving from left to right, emitter tips 130 can be controlled to emit lower and lower levels of microwave energy, as indicated by areas 120, 122, 124, 126, and 128. As the array 110 continues moving past the area 128 in the middle of layer 104, the emitter tips 130 can then be controlled to begin to emit higher and higher levels of microwave energy. As noted above, an energy delivery profile provides data to control each microwave emitter tip 114 to cause the microwave emitter array 110 to emit a fusing energy radiation pattern for each object layer, such as the radiation pattern shown on build material layer 104 indicated by areas 118, 120, 122, 124, 126, and 128. The controlled energy radiation patterns help create a desired thermal profile during the object's build process that compensates for expected thermal diffusion between object layers and expected thermal seepage into areas of powder surrounding the object.

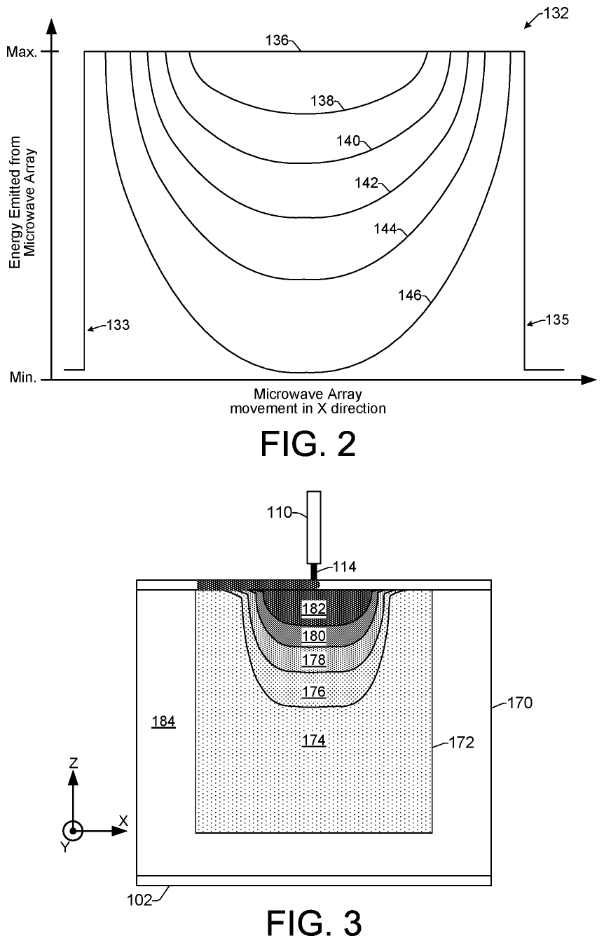

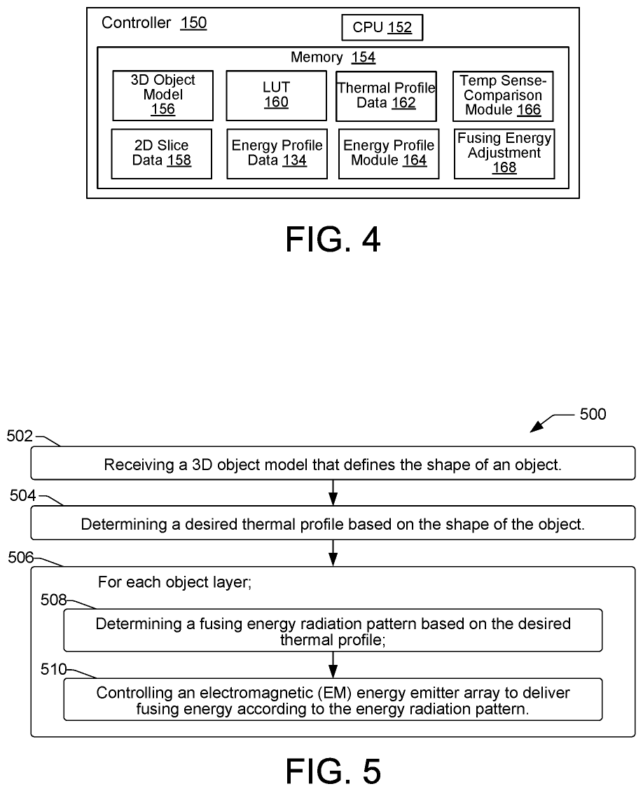

FIG. 2 shows a graph 132 of an example fusing energy delivery profile 134 (FIG. 4) that may be determined based on an object having a shape such as a rectangular block shape 172 (FIG. 3) as discussed above with respect to FIGS. 1A and 1B, and as shown in FIG. 3. A fusing energy delivery profile for a particular object can include fusing energy data determined in accordance with data that has been predetermined from prior empirical analysis of objects having similar shapes and build materials. For example, based on the shape of an object and the thermal characteristics of the material to be used to build the object, a look-up-table containing empirical data can be used to develop a fusing energy profile that can provide a distinct energy radiation pattern to be applied to each layer of the object during the build process (i.e., the 3D printing process). FIG. 3 shows an example of a rectangular shaped object 172 near the end of a build process in which fusing energy is being applied by a microwave emitter array 110 to the final layer or layers. The varying shades of the build material (174, 176, 178, 180, 182) making up the object 172 in FIG. 3 indicate a thermal profile resulting from the application of fusing energy to the object layers by the microwave emitter array 110. The non-shaded portion 184 comprises build material that has not been printed with a fusing agent and that is not part of the object 172. The graph 132 of FIG. 2 shows an example of an overall level of energy that can be applied to layers of the object during the 3D build/print process. Along the horizontal axis of graph 132, the movement of a microwave emitter array 110 across the print bed 102 from left to right in the X direction (see FIG. 1A) is shown. Along the vertical axis of graph 132, the relative amount of energy being emitted from the microwave emitter array 110 between a minimum and maximum level is shown. The graph 132 also shows a graphical representation of the left edge 133 and right edge 135 of the rectangular block object.

The graph 132 in FIG. 2 helps to illustrate how a microwave emitter array 110 can be controlled to apply varying levels of energy as the array 110 moves over build material layers during the process of building the object progresses. For example, when the first layer of the object is spread over the print bed 102 and processed, the maximum amount of fusing energy is applied to the layer as indicated by trace 136. In this example, the fusing energy applied to the first object layer does not vary, but remains constant at the maximum energy level. As subsequent object layers are spread over the print bed 102 and processed on top of the first layer, the applied energy from the microwave emitter array 110 varies in increasing amounts as the array 110 moves over the print bed 102 in the X direction. While the graph 132 represents an overall energy delivery profile 134 for the rectangular cube shaped object, each of the traces 136, 138, 140, 142, 144, and 146, represents an energy delivery sub-profile applied to a single layer of the object as the microwave emitter array 110 passes over that single layer during the build process. For example, assuming the object is to be built from 2000 layers of build material, trace 136 shows the energy sub-profile delivered to the first object layer, while trace 138 may show the energy sub-profile delivered to layer 400, trace 140 may show the energy sub-profile delivered to layer 800, and so on until the build process reaches trace 146 which may show the energy sub-profile delivered to the last layer 2000 of the object. In between each trace, there are intermediate energy sub-profile values that are not shown for the sake of clarity. There can be as many intermediate energy sub-profile values as there are layers in the object being built. That is, the microwave emitter array 110 can deliver a distinct energy sub-profile to each layer of the object. For example, trace 138 can show the energy sub-profile deliverable to layer 400, and the next layer 401 may have almost the same energy sub-profile value but it will be slightly closer to the value of trace 140.

Although the energy delivery profile and energy radiation patterns noted above are predetermined to create a desired thermal profile within an object, the example 3D printing system 100 can also include a thermal sensor 148 to sense the temperature of object layers during the object build process. A thermal sensor 148 can include, for example, a thermal imaging camera. The thermal sensor 148 can provide a thermal image of a build material layer such as layer 104, and the thermal image can be compared to a target thermal image for that layer according to a desired thermal profile. Such comparisons allow for adjustments to be made to predetermined energy radiation patterns and/or for additional energy to be applied to a material layer during an additional pass of the microwave emitter array 110 over the material layer. Such energy adjustments made during an object build process can provide additional control over the general thermal profile of an object to achieve the appropriate target fusing temperatures within the object layers.

As shown in FIG. 1A, an example 3D printing system 100 also includes a controller 150. FIG. 4 shows a block diagram of an example controller 150 in greater detail. As shown in FIG. 4, an example controller 150 can include a processor (CPU) 152, a memory 154, and other electronics (not shown) for communicating with and controlling various components of the 3D printing system 100, such as the print bed 102, fusing assembly 106, printbars 108, material dispenser (not shown), microwave emitter array 110, and individual microwave emitter tips 114 within the array 110. Other electronics in a controller 150 can include, for example, discrete electronic components and/or an ASIC (application specific integrated circuit). Memory 154 can include volatile (i.e., RAM) and nonvolatile memory components (e.g., ROM, hard disk, optical disc, CD-ROM, flash memory, etc.) comprising non-transitory, machine-readable (e.g., computer/processor-readable) media to provide for the storage of machine-readable coded program instructions, data structures, program instruction modules, JDF (job definition format), plain text or binary data in various 3D file formats such as STL, VRML, OBJ, FBX, COLLADA, 3MF, and other data and/or instructions executable by a processor 152 of the 3D printing system 100.

An example of executable instructions to be stored in memory 154 can include instructions associated with modules 164, 166, and 168, while an example of stored data can include 3D object model data 156, 2D slice data 158, a look-up-table (LUT) 160 with empirical data to associate an object's shape and material characteristics with fusing energy data, energy deliver profile data 134, and thermal profile 162. A 3D printing system 100 can receive a 3D object model 156 that represents an object to be printed. The object model 156 can include geometric information that describes the shape of the object, as well as information indicating colors, surface textures, the type of build material to be used in the object, and so on. In some examples, the processor 152 can generate 2D slice data 158 from a 3D object model 156, where each 2D slice defines a portion or portions of a powder layer that are to form a layer of the 3D object.

Instructions in an energy and thermal profile module 164 are executable by controller 150 to perform a process that can determine an energy delivery profile 134 and/or a thermal profile 162 for an object based on the shape of the object and the characteristics of the material to be used to build the object. The controller 150 can determine the shape and material makeup of the object from the 3D object model 156, and based on associations with objects having similar shapes and materials found in the LUT 160, for example, empirical fusing energy data stored in the LUT 160 can be gathered to develop a fusing energy profile 134 to apply during building of the object. The fusing energy profile 134 can provide a distinct energy radiation pattern to be applied to each layer of the object during the build process (i.e., the 3D printing process). The controller 150 can apply data from the energy delivery profile 134 to control individual microwave emitters 114 in the array 110 to radiate varying levels of energy in a particular pattern across each layer of the object.

In some examples, the controller 150 can determine a thermal profile 162 from empirical thermal data in the LUT 160 based on the shape of the object. A thermal profile 162 can include a desired thermal profile that can reduce thermal diffusion and thermal seepage in the object, as well as an expected thermal profile that will result from applying energy indiscriminately in a uniform radiation pattern to each object layer when building the object. A fusing energy delivery profile 134 can then be determined that will produce the desired thermal profile which can compensate for the thermal diffusion and thermal seepage from the expected thermal profile. The energy delivery profile 134 comprises data to control the individual microwave emitters 114 in the array 110 to radiate varying levels of energy in a particular pattern across each layer of the object.

In some examples, the controller 150 can execute instructions from a temperature sensing comparison module 166. The controller 150 can receive sensed thermal imaging data for an object layer from a thermal sensor 148 (e.g., a thermal imaging camera) during the object build process. The thermal imaging data can be compared to a target thermal image for the object layer according to a desired thermal profile 162. Based on the comparisons, executing instructions from a fusing energy adjustment module 168, the controller 150 can make adjustments to a predetermined energy delivery profile 134, or to energy radiation patterns, and/or it can cause additional energy to be applied to a material layer during an additional pass of the microwave emitter array 110 over the material layer. Such energy adjustments made during an object build process can provide additional control over the general thermal profile of an object to achieve the appropriate target fusing temperatures within the object layers.

FIGS. 5, 6, and 7, are flow diagrams showing example methods 500, 600 and 700, of 3D printing. Method 600 comprises extensions of method 500 and incorporates additional details of method 500. Methods 500, 600 and 700 are associated with examples discussed above with regard to FIGS. 1-4, and details of the operations shown in methods 500, 600 and 700 can be found in the related discussion of such examples. The operations of methods 500, 600 and 700 may be embodied as programming instructions stored on a non-transitory, machine-readable (e.g., computer/processor-readable) medium, such as memory/storage 154 shown in FIG. 4. In some examples, implementing the operations of methods 500, 600 and 700 can be achieved by a controller, such as a controller 150 of FIG. 4, reading and executing the programming instructions stored in a memory 154. In some examples, implementing the operations of methods 500, 600 and 700 can be achieved using an ASIC and/or other hardware components alone or in combination with programming instructions executable by a controller 150.

The methods 500, 600 and 700 may include more than one implementation, and different implementations of methods 500, 600 and 700 may not employ every operation presented in the respective flow diagrams of FIGS. 5, 6, and 7. Therefore, while the operations of methods 500, 600 and 700 are presented in a particular order within their respective flow diagrams, the order of their presentations is not intended to be a limitation as to the order in which the operations may actually be implemented, or as to whether all of the operations may be implemented. For example, one implementation of method 600 might be achieved through the performance of a number of initial operations, without performing other subsequent operations, while another implementation of method 600 might be achieved through the performance of all of the operations.

Referring now to the flow diagram of FIG. 5, an example method 500 of 3D printing begins at block 502 with receiving a 3D object model that defines the shape of an object to be printed in a layer-by-layer build process. The method continues with determining a desired thermal profile based on the shape of the object (block 504), and for each object layer (block 506), determining a fusing energy radiation pattern based on the desired thermal profile (block 508), and controlling an electromagnetic (EM) energy emitter array to deliver fusing energy to the object layer according to the energy radiation pattern (block 510).

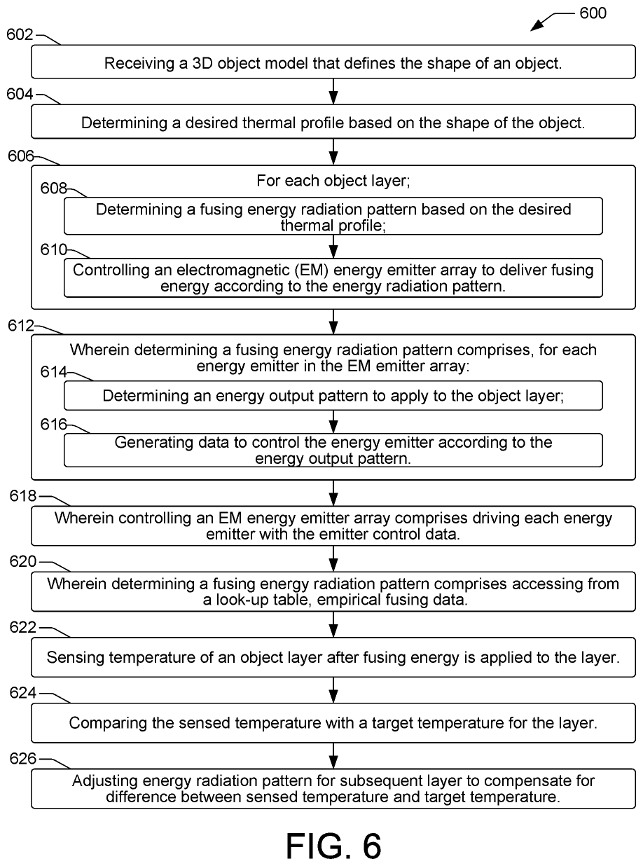

Referring now to the flow diagram of FIG. 6, another example method 600 of 3D printing is shown. Method 600 comprises extensions of method 500 and incorporates additional details of method 500. Accordingly, method 600 begins at block 602 with receiving a 3D object model that defines the shape of an object to be printed in a layer-by-layer build process. The method continues with determining a desired thermal profile based on the shape of the object (block 604), and for each object layer (block 606), determining a fusing energy radiation pattern based on the desired thermal profile (block 608), and controlling an EM energy emitter array to deliver fusing energy to the object layer according to the energy radiation pattern (block 610). In some examples, determining a fusing energy radiation pattern can include, for each energy emitter in the EM energy emitter array (block 612), determining an energy output pattern to apply to the object layer as the array traverses the object layer (block 614), and generating emitter control data to control the energy emitter according to the energy output pattern (block 616). In some examples, controlling an EM energy emitter array can include driving each energy emitter in the array with the emitter control data as the array traverses the object layer (block 618), and determining a fusing energy radiation pattern can include accessing from a look-up table, empirical fusing data associated with the shape of the object and a build material of the object (block 620). The method 600 can continue with sensing the temperature of an object layer after fusing energy is delivered to the object layer (block 622), comparing the sensed temperature of the object layer with a target temperature for the object layer, the target temperature accessed from the desired thermal profile (block 624), and adjusting a fusing energy radiation pattern for a subsequent object layer to compensate for a difference between the sensed temperature and the target temperature (block 626).

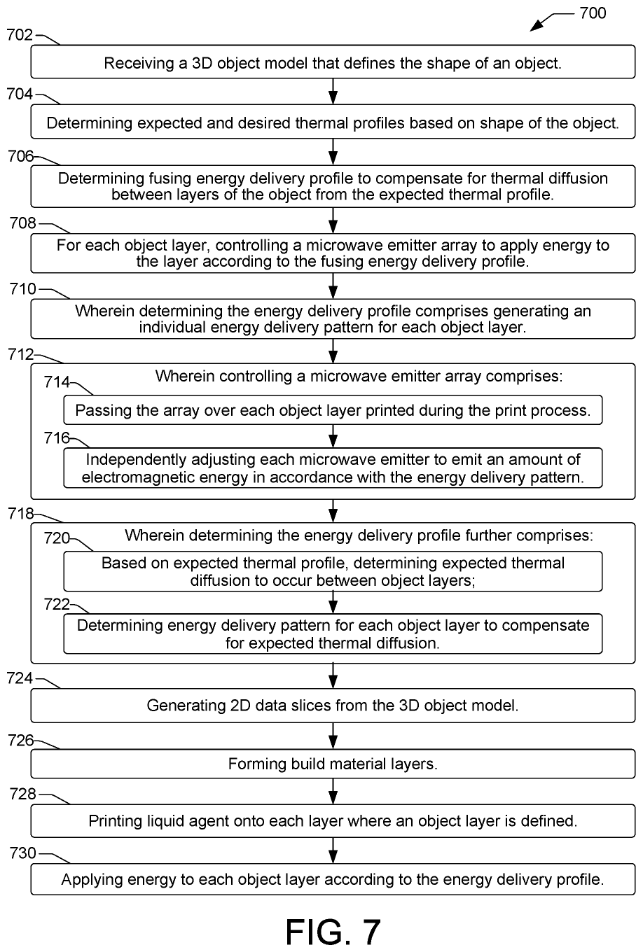

Referring now to the flow diagram of FIG. 7, another example method 700 of 3D printing is shown. As shown at block 702, the method 700 can include receiving a 3D object model that defines the shape of an object to be printed in a layer-by-layer print process. The method can also include determining an expected thermal profile and a desired thermal profile based on the object's shape (block 704), determining a fusing energy delivery profile to compensate for thermal diffusion between layers of the object from the expected thermal profile (block 706), and for each object layer printed during the print process, controlling a microwave emitter array to apply energy to the object layer according to the fusing energy delivery profile (block 708). In some examples, determining the energy delivery profile can include generating an individual energy delivery pattern for each object layer (block 710). In some examples, controlling a microwave emitter array can include (block 712) passing the array over each object layer printed during the print process (block 714), and as the array passes over each object layer, independently adjusting each microwave emitter within the array to emit an amount of electromagnetic energy in accordance with the energy delivery pattern for that object layer (block 716). In some examples, determining the energy delivery profile can also include (block 718) determining an expected thermal diffusion to occur between object layers based on the expected thermal profile (block 720) and determining the energy delivery pattern for each object layer to compensate for the expected thermal diffusion (block 722). The method 700 can also include generating 2D data slices from the 3D object model, where each 2D data slice to define an object layer within a build material layer (block 724), forming build material layers (block 726), printing a liquid agent onto each build material layer where an object layer is defined (block 728), and applying energy to each object layer according to the energy delivery profile (block 730).

What is claimed is:

1. A method of 3D printing comprising:
receiving a 3D object model that defines the shape of an object to be printed in a layer-by-layer build process;
determining a desired thermal profile based on the shape of the object; and,
for each object layer, determining a fusing energy radiation pattern based on the desired thermal profile, and controlling an electromagnetic (EM) energy emitter array to deliver fusing energy to the object layer according to the energy radiation pattern.

2. A method as in claim 1, wherein determining a fusing energy radiation pattern comprises:
for each energy emitter in the EM energy emitter array:
determining an energy output pattern to apply to the object layer as the array traverses the object layer; and,
generating emitter control data to control the EM energy emitter according to the energy output pattern.

3. A method as in claim 2, wherein controlling an EM energy emitter array comprises:
driving each energy emitter in the array with the emitter control data as the array traverses the object layer.

4. A method as in claim 1, wherein determining a fusing energy radiation pattern comprises accessing from a look-up table, empirical fusing data associated with the shape of the object and a build material of the object.

5. A method as in claim 1, further comprising:
sensing the temperature of an object layer after fusing energy is delivered to the object layer;
comparing the sensed temperature of the object layer with a target temperature for the object layer, the target temperature accessed from the desired thermal profile; and,
adjusting a fusing energy radiation pattern for a subsequent object layer to compensate for a difference between the sensed temperature and the target temperature.

6. A 3D printing system, comprising:
a controller to receive a 3D object model that defines the shape of an object to be printed, and to determine a fusing energy delivery profile based on the shape of the 3D object;
a build area in which to receive a layer of build material for the object;
a printing bar to dispense a liquid fusing agent onto a portion of the build material; and,
an electromagnetic (EM) energy emitter array to deliver fusing energy to the portion of the build material in a particular radiation pattern according to the fusing energy delivery profile.

7. A 3D printing system as in claim 6, wherein the EM energy emitter array comprises:
a microwave emitter array with a plurality of microwave emitter antennas, each microwave emitter antenna individually controlled to radiate amounts of energy according to control data as the array traverses the layer of build material.

8. A 3D printing system as in claim 7, further comprising:
a thermal sensor to sense a temperature of a layer of build material; and,
a controller to compare the sensed temperature with a target temperature of the layer, and to adjust the energy delivery profile based on the comparison.

9. A 3D printing system as in claim 6, wherein the printing bar comprises two printing bars, one on either side of the microwave emitter array, wherein either printing bar is to deposit a liquid fusing agent onto the portion of the build material prior to the microwave emitter array delivering fusing energy.

10. A 3D printing system as in claim 8, wherein the controller is to generate 2D slices from the 3D object model, the 2D slices to define the portion of the build material on which the liquid fusing agent is to be dispensed.

11. A method of 3D printing comprising:
receiving a 3D object model that defines the shape of an object to be printed in a layer-by-layer print process;
based on the object's shape, determining an expected thermal profile and a desired thermal profile;
determining a fusing energy delivery profile to compensate for thermal diffusion between layers of the object from the expected thermal profile; and,
for each object layer printed during the print process, controlling a microwave emitter array to apply energy to the object layer according to the fusing energy delivery profile.

12. A method as in claim 11, wherein determining the energy delivery profile comprises generating an individual energy delivery pattern for each object layer.

13. A method as in claim 12, wherein controlling a microwave emitter array comprises;
passing the array over each object layer printed during the print process; and,
as the array passes over each object layer, independently adjusting each microwave emitter within the array to emit an amount of electromagnetic energy in accordance with the energy delivery pattern for that object layer.

14. A method as in claim 12, wherein determining the energy delivery profile further comprises:
based on the expected thermal profile, determining an expected thermal diffusion to occur between object layers; and,
determining the energy delivery pattern for each object layer to compensate for the expected thermal diffusion.

15. A method as in claim 11, further comprising:
generating 2D data slices from the 3D object model, each 2D data slice to define an object layer within a build material layer;
forming build material layers;
printing a liquid agent onto each build material layer where an object layer is defined; and,
applying energy to each object layer according to the energy delivery profile.
